(19) United States
(12) Patent Application Publication
(10) Pub. No.: US 2020/0142807 A1
(43) Pub. Date: May 7, 2020

(54) DEBUGGER WITH HARDWARE TRANSACTIONAL MEMORY

(71) Applicant: International Business Machines Corporation, Armonk, NY (US)

(72) Inventors: Wei Guo, Shanghai (CN); Xian Dong Meng, Shanghai (CN); Jia He, Shanghai (CN); Zhong Li, Shanghai (CN)

(21) Appl. No.: 16/179,438

(22) Filed: Nov. 2, 2018

(51) Int. Cl. G06F 11/36

(52) U.S. Cl. CPC G06F 11/3648

(57) ABSTRACT

A method, computer system, and a computer program product for a debugger with a hardware transactional memory is provided. A transaction is created to issue at least one request for accessing a memory location of a hardware transactional memory. A message is received from the hardware transactional memory indicating a conflict of access that is generated in response to the memory location being accessed by a program debugged by the debugger. In response to receiving the message from the hardware transactional memory, information associated with the conflict of access is collected to report the conflict of access.

### BACKGROUND

The present invention generally relates to debugging of program instructions, and more specifically, to a debugger with hardware transactional memory.

It is a popular and efficient debug mechanism to use hardware watchpoints in a debugger during software development for software developers to identify software bug efficiently. The hardware watchpoint can be used to “watch” some memory address (virtual or physical address) for a debug configuration. That is, an exception can be triggered when a specified memory address is modified. At the backend, hardware watchpoint facilities may watch the memory bus and throw an exception when the memory address being accessed matches the memory address to be monitored.

However, the number of the hardware watchpoint facilities is limited. Therefore, the debugger can only monitor a few memory locations simultaneously, which limits the debug efficiency for software developer to monitor a number of scattered memory addresses. There is a need for an improved debugger.

### SUMMARY

Example embodiments of the present disclosure provide a computer-implemented method, a system, and a computer program product for a debugger with a hardware transactional memory.

In an aspect, there is provided a computer-implemented method. The method comprises creating a transaction to issue at least one request for accessing a memory location of a hardware transactional memory in response to a program being debugged. The method further comprises receiving a message from the hardware transactional memory indicating a conflict of access that is generated in response to the memory location being accessed by the program. The method further comprises collecting information associated with the conflict of access to report the conflict of access in response to receiving the message from the hardware transactional memory.

In another aspect, there is provided a system. The system comprises a processing unit; and a memory coupled to the processing unit and storing instructions thereon. The instructions, when executed by the processing unit, performing acts including creating a transaction to issue at least one request for accessing a memory location of a hardware transactional memory in response to a program being debugged. The acts further include receiving a message from the hardware transactional memory indicating a conflict of access that is generated in response to the memory location being accessed by the program. The acts further include collecting information associated with the conflict of access to report the conflict of access, in response to receiving the message from the hardware transactional memory.

In yet another aspect, there is provided a computer program product being tangibly stored on a non-transient machine-readable medium and comprising machine-executable instructions, the instructions, when executed on a device, causing the device to create a transaction to issue at least one request for accessing a memory location of a hardware transactional memory in response to a program being debugged. The instructions further cause the device to receive a message from the hardware transactional memory indicating a conflict of access that is generated in response to the memory location being accessed by the program. The instructions further cause the device to collect information associated with the conflict of access to report the conflict of access, in response to receiving the message from the hardware transactional memory.

It is to be understood that the Summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a cloud computing node according to an embodiment of the present disclosure.

FIG. 2 illustrates a cloud computing environment according to an embodiment of the present disclosure.

FIG. 3 illustrates abstraction model layers according to an embodiment of the present disclosure.

FIG. 4 illustrates an environment in which embodiments of the present disclosure may be implemented; and

FIG. 5 is a flowchart illustrating a method of debugging program instructions in accordance with embodiments of the present disclosure.

Throughout the drawings, the same or similar reference numerals represent the same or similar elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, Python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

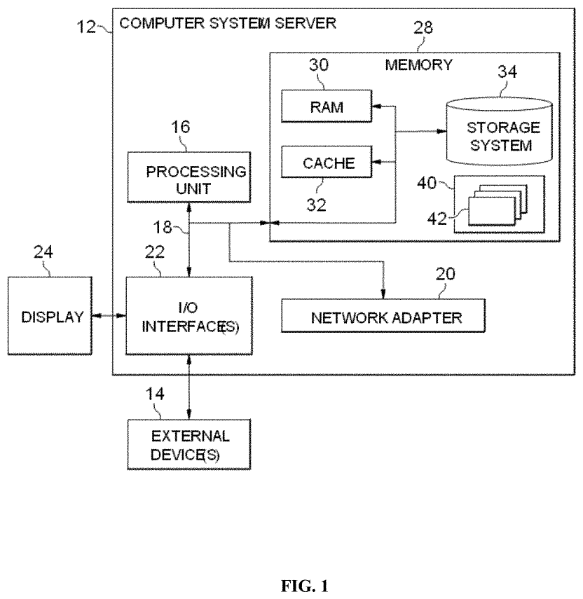

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

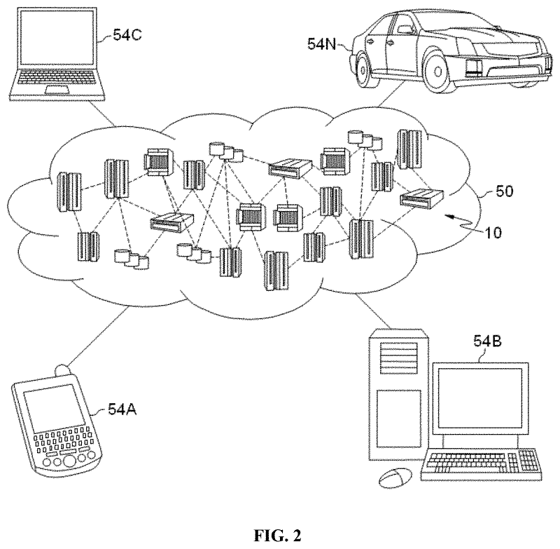

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof thereby allowing cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

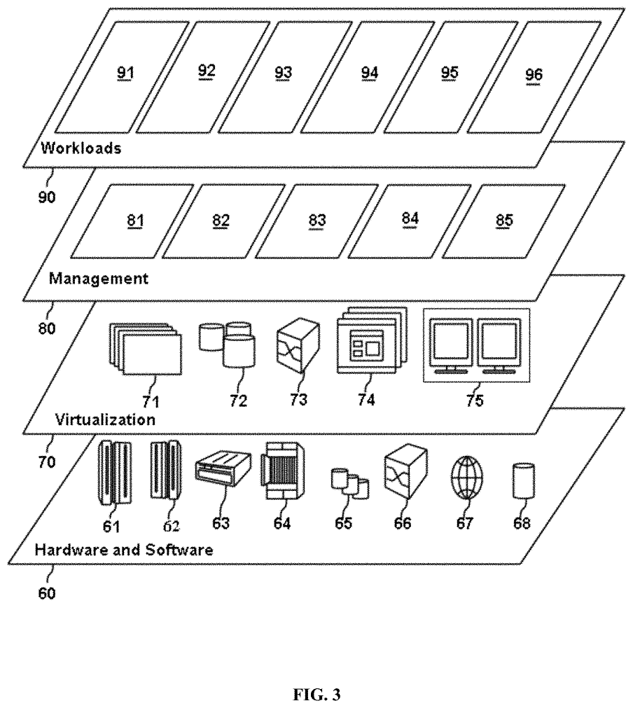

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 may include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 may provide an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 may provide dynamic procurement of computing resources and other resources that are utilized to perform tasks within the cloud computing environment. Metering and Pricing 82 may provide cost tracking as resources are utilized within the cloud computing environment, and billing or invoicing for consumption of these resources. In one example, these resources may include application software licenses. Security may provide identity verification for cloud consumers and tasks, as well as protection for data and other resources. User portal 83 may provide access to the cloud computing environment for consumers and system administrators. Service level management 84 may provide cloud computing resource allocation and management such that required service levels are met. Service Level Agreement (SLA) planning and fulfillment 85 may provide pre-arrangement for, and procurement of, cloud computing resources for which a future requirement is anticipated in accordance with an SLA.

Workloads layer 90 may provide examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and debug processing 96.

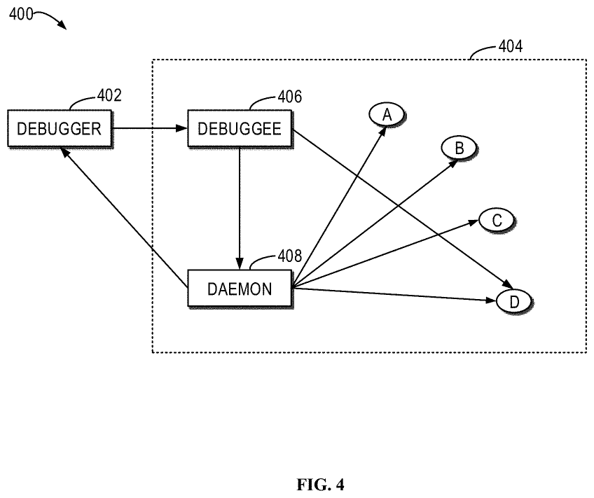

FIG. 4 is a schematic diagram illustrating an example environment 400 in which embodiments of the present disclosure may be implemented. It is to be understood that the environment 400 is described only for the purpose of illustration without suggesting any limitations as to the scope of the present disclosure. The present disclosure can be embodied within any other suitable environments.

A debugger is a computer program that is used to test and debug another program. The program debugged by the debugger is also referred to as a debuggee. The debugger may watch one or more memory locations to determine whether the memory locations are being accessed by the debuggee or not. An access to one of the memory locations may be a read access or a write access.

FIG. 4 shows a debugger 402 being used to test and debug a debuggee 406. As shown in FIG. 4, the address space 404 for the debuggee 406 may include a number of memory locations to be monitored on a hardware transactional memory, for example, memory locations A, B, C, and D. The four memory locations A to D are shown only for the purpose of illustration without suggesting any limitations to the scope of the present disclosure. The present disclosure may be applied to any other suitable number of memory locations.

Transactional memory may attempt to simplify concurrent programming by allowing a group of load and store instructions to execute in an atomic way. The abstraction of atomicity in transactional memory may include a hardware mechanism to detect conflicts and undo any changes made to shared data. Hardware transactional memory may comprise hardware transactions implemented entirely in processor hardware. For hardware transactions, data may be stored in hardware registers and cache, such that all cache actions are done atomically in hardware, and data in the hardware transactional memory is only written to the main memory upon committing the transaction.

A piece of a program may be defined as a transaction that has “atomic” property. The atomic property means that the transaction is indivisible and each transaction must succeed or fail as a complete unit; it can never be only partially complete. For example, either the entire instruction block of the transaction is executed successfully, or none of the instructions in the block are executed as if nothing has been changed.

The hardware transactional memory can monitor/check whether there is a conflict with the task of the debuggee 406, which may be transactional or non-transactional. A task that has the atomic property is called as transactional, while a task that does not have the atomic property is called as non-transactional. For ease of discussion, the task of the debuggee 406 will not be referred to as transactional or non-transactional, unless indicated otherwise.

The conflict may be caused by simultaneous accesses to the same memory location by a transaction and another task, and at least one of the accesses is a write access. The task of the monitor daemon 408 may be transactional. For example, if the transaction of the monitor daemon 408 modifies a memory location and the task of the debuggee 406 reads the same memory location, the transaction can fail over immediately. In another example, if the transaction of the monitor daemon 408 reads a memory location and the task of the debuggee 406 modifies the same memory location, the transaction can fail over immediately. In a further example, if both the transaction of the monitor daemon 408 reads a memory location and the task of the debuggee 406 modify the same memory location, the transaction (and the task, if transactional) could fail over immediately.

The debugger 402 may create a monitor daemon 408 that is used to perform a transactional task, also referred to as a transaction. The transaction may include a number of operations or instructions, and the transaction is indivisible and may succeed or fail as a complete unit. The monitor daemon 408 may access various memory locations to be “monitored,” for example, memory locations A to D. The memory locations to be monitored are not necessarily continuous. When the monitor daemon 408 accesses the memory locations, the memory locations may be tagged with a transaction label. In some cases, the tag may be in cache line at hardware.

The monitor daemon 408 may access the memory locations in a loop. If the task of the debuggee 406 modifies one of the memory locations A to D (for example, D), the transaction of the monitor daemon 408 may fail immediately and the monitor daemon 408 can be redirected to a failover handler of the monitor daemon 408. In the failover handler, the monitor daemon 408 can detect the conflict, log the event and report to the developer in time.

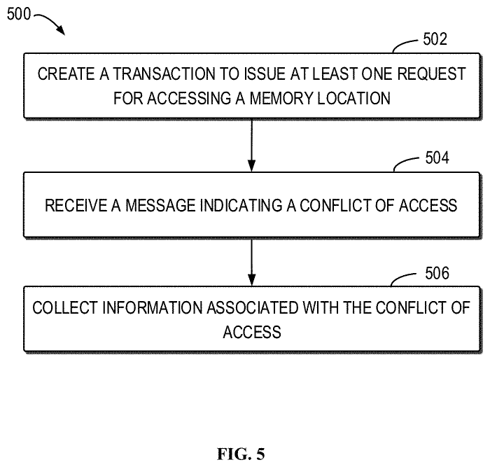

FIG. 5 is a flowchart illustrating a method 500 of debugging program instructions in accordance with embodiments of the present disclosure. The method 500 will now be described with reference to FIG. 4 that shows the example environment 400. It is to be understood, however, the present disclosure can be embodied within any other suitable environments.

At 502, the debugger 402 may create a transaction to issue at least one request for accessing a memory location of a hardware transactional memory. For example, the debugger 402 may create a monitor daemon 408 that is used to perform a transactional task, also referred to as a transaction. For example, the monitor daemon 408 may issue at least one request for accessing the memory location D on the hardware transactional memory.

A conflict of access could by caused if two tasks are accessing a same memory location, at least one of the two tasks being a write access. To monitor access of the debuggee 406 to one or more memory locations, it is possible to produce a conflict of access by accessing the memory locations through the monitor daemon 408. The monitor daemon 408 may issue read request(s) or write request(s) for accessing the memory locations.

In some embodiments, the monitor daemon 408 may issue read requests for accessing the memory locations A, B, C, and D to monitor write access of the debuggee 406 to the memory locations A, B, C, and D. For example, the monitor daemon 408 may issue one or more read requests for accessing the memory location D to monitor write access to the memory location D.

In some embodiments, to monitor read access of the debuggee 406 to the memory locations A, B, C, and D, the monitor daemon 408 may read data from the memory locations A, B, C, and D, and the monitor daemon 408 write the same data to the respective memory locations A, B, C, and D. For example, the monitor daemon 408 may issue one or more read requests for reading data from the memory location D, and issue one or more write requests for writing the same data to the memory location D, to monitor read access to the memory location D. To ensure that the data is not changed between the read operation and the write operation, the consistency window between read and write operations can be eliminated by load-link and store-conditional (LL/SC). LL/SC are a pair of instructions used in multithreading to achieve synchronization. Load-link returns the current value of a memory location, while a subsequent store-conditional to the same memory location may store a new value only if no updates have occurred to that location since the load-link. Together, this implements a lock-free atomic read-modify-write operation. It is to be understood, however, any other suitable method can be used to ensure that the data is not changed between the read operation and the write operation.

For ease of description, the embodiments of the present disclosure will now be described with respect to read requests for accessing the memory locations to monitor write access of the debuggee 406 to the memory locations. It is to be understood, however, the embodiments may be applied to monitoring read access of the debuggee 406 to the memory locations.

The creation of the transaction will now be described with reference to some embodiments. The debugger 402 may stop the debuggee 406 via a trap interface, for example, process trace (i.e., ptrace). Ptrace is a system call found in Unix and several Unix-like operating systems. By using ptrace, one process can control another, enabling the controller to inspect and manipulate the internal state of its target. Ptrace may be provided only for the purpose of illustration and any other suitable method can be used to stop the debuggee 406.

When the debuggee 406 is stopped, the debugger 402 can inject a monitor daemon 408 to the debuggee 406 to create the monitor daemon 408. To this end, the debugger 402 can modify the instructions of the debuggee 406, so that the debuggee 406 can load a predefined library including program codes that implements the monitor daemon 408. Upon execution of the program codes, the monitor daemon 408 can be created and may be running as a thread. FIG. 4 shows that the monitor daemon 408 has been created by the debugger 402 via the debuggee 406 and is running as a thread. The library may parse arguments provided by the debugger 402, for example, a list of memory addresses to be monitored, and instantiate or fork a monitor daemon 408 as desired. Fork is an operation whereby a process creates a copy of itself, and fork is the primary method of process creation on Unix-like operating systems. In some instance, the list of memory addresses may include a plurality of effective addresses in the address space 404. The monitor daemon 408 may be implemented as a thread, for example.

Upon creation, the monitor daemon 408 may enter a transactional state, and, in the transaction, the monitor daemon 408 may traverse the list of memory addresses and issue one or more requests for accessing the memory locations A to D indicated by the memory addresses one by one. For example, the monitor daemon 408 may iteratively access the memory locations A to D and wait for something (e.g., an event) to happen.

In some embodiments, the hardware transactional memory may tag the memory locations A to D with a transaction label, when the monitor daemon 408 accesses the memory locations. If the task of the debuggee 406 modifies any of the memory locations A to D while the monitor daemon 408 is accessing the memory location, the hardware transactional memory may identify a transaction conflict, also referred to as a conflict of access. In response to the conflict of access, the hardware transactional memory may failover the transaction of the monitor daemon 408 immediately.

In some embodiments, the monitor daemon 408 may be configured with a failover handler configured to collect and report the information associated with the conflict of access, also referred to as conflict information. The conflict information may include the memory location being accessed by the debuggee 406 and the instruction of the debuggee 406 that results in the conflict of access. The failover handler may be activated in response to a conflict of access being detected.

In some embodiments, the monitor daemon 408 may be associated with or correlated to a central processing unit (CPU) thread with preemption disabled. Preemption is the act of temporarily interrupting a task being carried out by a computer system, without requiring its cooperation, and with the intention of resuming the task at a later time. By disabling preemption, a timely response to the conflict can be achieved.

At 504, the debugger 402 may receive a message indicating a conflict of access. For example, the message may be received by the monitor daemon 408 and forwarded to the debugger 402. The conflict of access may be generated in response to the memory location being accessed by the debuggee 406. If the monitor daemon 408 only accesses the memory location D in a loop, the memory location being accessed by the debuggee 406 is the memory location D. In this case, if the memory locations A to D are to be monitored, four instances of the monitor daemon 408 may be created and each instance is used to monitor one of the memory locations A to D. If the monitor daemon 408 accesses the memory locations A to D in a loop, the memory location being accessed by the debuggee 406 may be any one of the memory locations A to D. For ease of description, reference now is made to the memory location D as the memory location being accessed by the debuggee 406.

For example, the debuggee 406 modifies data in the memory location D, as shown in FIG. 4, and the debuggee 406 breaks the transaction of the monitor daemon 408 thereby leading to a transactional conflict and then lead to a transaction failover of the monitor daemon 408. The monitor daemon 408 fails over and activate its failover handler, which is automatically forced by the hardware transactional memory.

At 506, in response to receiving the message from the hardware transactional memory, the failover handler of the monitor daemon 408 may collect the information associated with the conflict of access.

In some embodiments, the hardware transactional memory may track and record the transaction failure information. When a transaction failure happens, the hardware transactional memory may automatically record some information, for example, Transaction Failure Instruction Address (an effective address of the instruction who accesses the memory location D) which leads to transaction conflict. This can be implemented by any method currently known or to be developed in the future.

In some embodiments, the debugger 402 or the failover handler of the monitor daemon 408 may record the effective memory address of the memory location D. The effective memory address may also be referred to as a Transaction Failure Data Address. For example, a register is provided to record a physical address of the memory location that leads to the transaction failure. For example, the register may be a per thread register, referred to as TFDAR (Transaction Failure Data Address Register). In the hardware level, the cache line of the memory usually includes a physical address of the memory location D as a tag to identify different memory addresses mapping to the same cache line.

The effective address may be obtained from the physical address by means of the register. For example, the operating system translates a physical address to an effective address, and the operating system provides an interface to tell the debugger that works at the user space. For example, when creating the monitor daemon 408, the monitor daemon 408 may retrieve the physical address for the effective addresses to be monitored, and maintain a mapping table between the effective addresses and the physical addresses.

When the transaction failure happens, the register may record the physical address of the memory location accessed by the debuggee 406. The monitor daemon 408 may look up the mapping table and determine the effective address corresponding to the physical address based on the mapping table.

In some embodiments, if a number of memory locations are watched, for example A, B, C, and D, a dedicated monitor daemon may be launched or created for each of the memory locations. Since each monitor daemon 408 accesses only one memory location, the failover of the transaction of each monitor daemon 408 may indicate the effective memory address that is accessed by the debuggee 406.

In response to receiving the message, the monitor daemon 408 may jump to the failover handler of the monitor daemon 408. The monitor daemon 408 may send a trap to the debuggee 406 to pause the debuggee 406. Trap is a function that responds to hardware signals and other events. The failover handler of the monitor daemon 408 can be defined to collect conflict information and report the conflict information to the debugger 402.

The debugger 402 may check the conflict information, log the conflict event indicating the conflict of access, and determine whether to resume the debuggee 406 or notify the user interactively, depending on user settings. For example, if the debugger setting is to stop the debuggee 406, the debugger 402 may signal the debuggee 406 to stop immediately and report to the debugger 402. The debugger 402 may determine whether execution of the debuggee 406 can be resumed. For example, if the debugger 402 wants the debuggee 406 to continue, the debugger 402 can instruct the monitor daemon 408 to issue the requests for accessing the memory locations A to D.

In some embodiments, the task of the debuggee 406 may be a transaction as well. If two transactions simultaneously access the same memory location, at least one of the transactions might fail. Therefore, if the debuggee 406 and the monitor daemon 408 simultaneously access the memory location D, the transaction of the debuggee 406 may fail and the debuggee 406 may be interrupted by the monitor process. To solve this problem, a hardware control register may be used to store and determine a priority for failover in the current CPU thread. If a transaction of a lower priority conflicts with another transaction of a higher priority, the transaction of the lower priority may failover and the transaction of the higher priority may proceed as if nothing has happened.

For example, the monitor daemon 408 can be defined with the lowest priority for failover. The lowest priority may be reserved for debugging purpose. The monitor daemon 408 must failover when the monitor daemon 408 conflicts with another transaction of a higher priority. The transaction with a higher priority may proceed as if nothing has happened. If the debuggee 406 is implemented as a transaction or a transactional program, the transaction of the monitor daemon 408 may be triggered to failover while maintaining the transaction of the debuggee 406, in response to receiving the message from the hardware transactional memory. The impact for watching the memory locations on the task carried out by the debuggee 406 can be reduced, and the debugger 402 may be flexibly controlled.

In accordance with embodiments of the present disclosure, the method may achieve the same effect as hardware breakpoints and the method may monitor a number of scattered memory locations. The method may be scalable and simultaneously monitor many scattered memory locations. The scattered memory locations may not be not limited to hardware watchpoint registers. The method may reuse the hardware transactional memory and scale the watchpoint number to hundreds or thousands. The method may be particularly beneficial for monitoring a non-shared memory, which is a memory that may not be simultaneously accessed by multiple programs.

In addition, the conflict of access is detected by the hardware transactional memory, which is more efficient than software-based watchpoint solutions. In some embodiments, if a write access to a memory location is monitored, a transaction may be used to read from the memory location. In this way, even if the debuggee writes the data that is the same as the data stored on the memory location, the write access can still be detected.

Generally, conventional watchpoint solutions may only monitor a write access to the memory location, and cannot monitor a read access to the memory location. In some embodiments of the present disclosure, a read access to the memory location may be monitored by reading data from the memory location and writing the same data into the memory location.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method comprising:
creating, by one or more processors, a transaction to issue at least one request for accessing a memory location of a hardware transactional memory in response to a program being debugged, the hardware transactional memory being a non-shared memory;
receiving, by the one or more processors, a message from the hardware transactional memory indicating a conflict of access that is generated in response to the memory location being accessed by the program; and
collecting, by the one or more processors, information associated with the conflict of access to report the conflict of access, in response to receiving the message from the hardware transactional memory.

2. The method of claim 1, wherein said collecting the information comprises:
determining, by the one or more processors, at least one of the following:
an effective address of an instruction of the program that accesses the memory location; and
an effective address of the memory location.

3. The method of claim 1, wherein the transaction issues a plurality of requests for accessing a plurality of memory locations of the hardware transactional memory, the plurality of requests comprising the at least one request and the plurality of memory locations comprising the memory location.

4. The method of claim 3, wherein said collecting the information comprises:
obtaining, by the one or more processors and from a register, a physical address of the memory location that is accessed by the program; and
translating, by the one or more processors, the physical address of the memory location to an effective address of the memory location.

5. The method of claim 1, wherein the program has a higher priority than the transaction, and wherein said collecting the information comprises:
in response to receiving the message from the hardware transactional memory, triggering, by the one or more processors, a failover of the transaction while maintaining the program.

6. The method of claim 5, wherein priorities of the transaction and the program are stored in a register.

7. The method of claim 1, wherein the at least one request comprises a read request, and wherein the message indicates a conflict of access that is generated in response to the memory location being written by the program.

8. The method of claim 1, wherein the at least one request comprises a read request for reading data from the memory location and a write request for writing the data onto the memory location, and the message indicates a conflict of access that is generated in response to the memory location being read by the program.

9. A system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
creating a transaction to issue at least one request for accessing a memory location of a hardware transactional memory in response to a program being debugged, the hardware transactional memory being a non-shared memory;
receiving a message from the hardware transactional memory indicating a conflict of access that is generated in response to the memory location being accessed by the program; and
collecting information associated with the conflict of access to report the conflict of access, in response to receiving the message from the hardware transactional memory.

10. The system of claim 9, wherein said collecting the information comprises:
determining at least one of at least one of the following:
an effective address of an instruction of the program that accesses the memory location, and
an effective address of the memory location.

11. The system of claim 9, wherein the transaction issues a plurality of requests for accessing a plurality of memory locations of the hardware transactional memory, the plurality of requests comprising the at least one request and the plurality of memory locations comprising the memory location.

12. The system of claim 11, wherein said collecting the information comprises:
obtaining, from a register, a physical address of the memory location that is accessed by the program; and
translating the physical address of the memory location to an effective address of the memory location.

13. The system of claim 9, wherein the program has a higher priority than the transaction, and wherein said collecting the information comprises:
in response to receiving the message from the hardware transactional memory, triggering a failover of the transaction while maintaining the program.

14. The system of claim 13, wherein priorities of the transaction and the program are stored in a register.

15. The system of claim 9, wherein the at least one request comprises a read request, and wherein the message indicates a conflict of access that is generated in response to the memory location being written by the program.

16. The system of claim 9, wherein the at least one request comprises a read request for reading data from the memory location and a write request for writing the data onto the memory location, and the message indicates a conflict of access that is generated in response to the memory location being read by the program.

17. A computer program product, comprising:
one or more computer-readable storage media and program instructions stored on at least one of the one or more tangible storage media, the program instructions executable by a processor to cause the processor to perform a method comprising:
creating a transaction to issue at least one request for accessing a memory location of a hardware transactional memory in response to a program being debugged, the hardware transactional memory being a non-shared memory;
receiving a message from the hardware transactional memory indicating a conflict of access that is generated in response to the memory location being accessed by the program; and
collecting information associated with the conflict of access to report the conflict of access, in response to receiving the message from the hardware transactional memory.

18. The computer program product of claim 17, wherein the instructions, when executed on the device, cause the device to determine at least one of the following:
an effective address of an instruction of the program that accesses the memory location; and
an effective address of the memory location.

19. The computer program product of claim 17, wherein the transaction issues a plurality of requests for accessing a plurality of memory locations of the hardware transactional memory, the plurality of requests comprising the at least one request and the plurality of memory locations comprising the memory location.

20. The computer program product of claim 19, wherein the instructions, when executed on the device, cause the device to:
obtain, from a register, a physical address of the memory location that is accessed by the program; and
translate the physical address of the memory location to an effective address of the memory location.
